(19) United States
(12) Patent Application Publication
(10) Pub. No.: US 2025/0027465 A1
(43) Pub. Date: Jan. 23, 2025

(54) AIR ACCELERATOR AND AIR COOLER APPARATUS IN INTERNAL COMBUSTION ENGINES

(71) Applicant: Müjdat KANDEMIR, Basiskele-KOCAELI (TR)

(72) Inventor: Müjdat KANDEMIR, Basiskele-KOCAELI (TR)

(21) Appl. No.: 18/548,819

(22) PCT Filed: Aug. 10, 2022
(86) PCT No.: PCT/TR2022/050834

§ 371 Date: Sep. 1, 2023

(30) Foreign Application Priority Data
Jun. 22, 2022 (TR) 2022/010411

(51) Int. Cl. F02M 31/20; F02M 35/10

(52) U.S. Cl. CPC F02M 31/20; F02M 35/10144; F02M 35/10262

(57) ABSTRACT

An air accelerator and air cooler apparatus developed for use in all internal combustion engines includes a conical structure and a perforated surface with angled directions.

### FIELD OF THE INVENTION

The present invention relates to the air accelerator and air cooler apparatus developed for use in all internal combustion engines.

### STATE OF THE ART

Internal combustion engines are machines formed by means of moving the part called the piston by the pressure created by burning the fuel in a limited area called the combustion chamber inside the engine.

An assembly consisting of a metallic cylinder with a piston inside which was considered as the predecessor of the internal combustion engine was developed in Paris in 1673 by physicist Christiaan Huygens and his assistant Denis Papin. Belgian engineer Étienne Lenoir patented a two-stroke internal combustion engine in 1859 under the name “gas and expanded air engine” and he developed the first electrically fired and water-cooled internal combustion engine in 1860.

The reason why these engines are called internal combustion engines is that combustion takes place inside the engine. In external combustion engines, they are called external combustion engines because combustion takes place outside. For example: Steam machine.

Extremely compact engines could be produced and automobiles were formed by moving the combustion chamber into the engine in internal combustion engines.

Today, internal combustion engines are all engines operating with diesel, gasoline, lpg and cng fuel.

Acceleration of air is important in internal combustion engines. However, the air accelerating apparatuses available only serve to increase the speed of the air. It also does not reduce the temperature.

For example, the part named Tornado Gas Saver KI70 Air Management System in the state of the art just freezes the air on its axis and increases the air velocity. It has no effect on lowering the temperature of the air.

Also in the existing patents, in the files numbered U.S. Pat. Nos. 6,932,049, 6,840,212, 6,796,296, 7,267,098, 7,028,663, it is seen that only freezing the air within its axis and increasing the air velocity, has no effect on reducing the temperature of the air.

### Definition of the Invention

Said invention eliminates the disadvantages described in the state of the art and fulfills the needs.

The present invention provides to reduce the temperature while accelerating the air.

The present invention increases the engine torque in diesel engines, gasoline engines, CNG and LPG engines. The pressure on the piston surface from the combustion is greater since the air in the section where the apparatus is attached is cooled and accelerated by the apparatus, the air taken into the combustion chamber is colder and more than before.

Since the present invention does not operate with an abrasive material, the economic life of the product is long. Plastic material, on the other hand, is equivalent to 2-3 years, metal material and engine life.

The engine operates with less vibration with the present invention since it reduces the vibration levels in the engines.

The present invention provides at least 15% reduction in sound level in engines. Air density increases since the present invention increases the speed of the air sucked in engines and at the same time reduces the temperature of the sucked air, more air and oxygen-enriched air enter the combustion chamber of the engines, resulting in additional torque for the engine with the help of these features. At this level it is at least 15%.

In said invention, the engines will be able to continue to operate in the standard operating environment, and excessive engine heat will not occur with the help of the oxygen-enriched air.

It will affect the exhaust gas temperature to decrease by an amount close to half, and it will help the exhaust gases to be discharged in a better form than before when we use it in the exhaust manifold part of the engines in the present invention.

Fires occur in CNG powered engines, especially in municipal buses, due to the fact that the exhaust gases rise above 600 degrees in hot summer months. Phoenix energy device halves the exhaust temperature and prevents possible fires, only this feature provides passengers with a safer travel opportunity.

The present invention also provides the following advantages;
Engines start quickly
Engine body temperatures provide a decrease compared to the past.
It increases the power of the engine, the additional torque in the engine is at the level of 20%
Added power provides driving comfort and fuel economy.
The engine density and fluid properties are preserved as they were on the first day, since the oils used in the engines cause less engine body heat, causing the lubrication to be more effective and longer.

### REFERENCE LIST

1. Hole
2. Conical structure
3. Narrow section
4. Wide side

### BRIEF DESCRIPTION OF DRAWINGS

FIG. 1: Representative view of the present invention

FIG. 2: Representative general view of the present invention

FIG. 3: Sectional view of the present invention

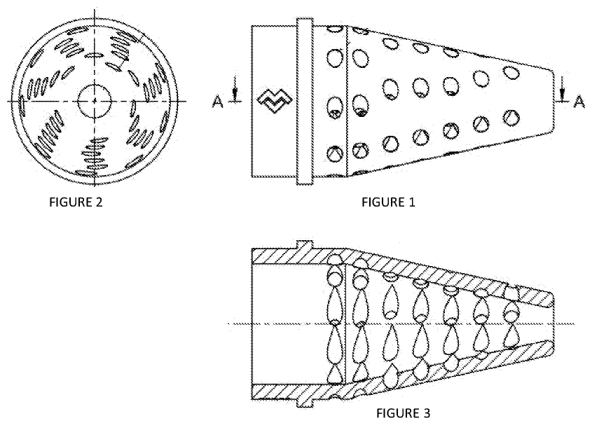

### DESCRIPTION OF THE INVENTION

The present invention is an air accelerator and air cooler apparatus in internal combustion engines, characterized in that; It has a conical structure (2) and has a perforated (1) surface with angled directions.

The angles of the hole (1) are in angular form, which allows the direction of the air passing through the inserted pipe to move in a helical structure The angle range can be in the range of 30-45 degrees depending on the vehicle and the diameter of the pipe. Maximum cooling and acceleration gives the desired result in these angle ranges. The number of holes (1), the wall thickness of the apparatus, the hole (1) angles vary according to the vehicle (which vehicle will be used in the engine).

The hole (1) and conical structure (2) shape, inlet and traction diameters vary depending on the size of the internal combustion engines.

The diameter of the holes (1) drilled between 30 and 45 degrees on the conical structure (2) surface is a minimum of 3 mm and a maximum of 25 mm.

The initial narrow part (3) of the conical structure (2) has the diameters of the hole (1) from 15 to 80 mm.

The diameters of the wide side (4) of the conical structure (2) also vary between 40 mm and 250 mm, but much larger diameters are produced than for land vehicles in applications on ships.

The friction coefficient decreases and cooling occurs by the faster air transmission since the air passing through the angular holes (1) starts to move in the form of an elongated arc by taking a helical direction with the invention.

### Intended Use of the Invention

The inventive apparatus is mounted inside the air intake pipe before the part called the throttle valve (1^{st} use).

If the same vehicle requires 2^{nd} and/or more apparatus, it is mounted to the turbo engine inlet with the air filter (2^{nd} use).

If an application is to be made to the exhaust, it can also be mounted inside the exhaust line before the exhaust silencer (3^{rd} use).

It is also used to cool the liquid by being mounted on the vehicle's liquid cooling return line before the radiator inlet (4^{th} use).

The hydraulic cooling can also perform cooling before the heat exchanger in vehicles with hydraulic components (5^{th} use).

First of all, the diameter measurement is taken according to the brand and model since the pipeline diameter of each vehicle varies. The apparatus is produced according to this diameter measure. The number of holes (1) and their spacing vary according to the diameter angle.

1. An air accelerator and air cooler apparatus in internal combustion engines, comprising a conical structure and a perforated surface with angled directions.

2. The air accelerator and air cooler apparatus in internal combustion engines according to claim 1, wherein the hole angles have an angular form in the range of 30-45 degrees, which allows the air direction to move in a spiral structure in the inserted pipe.

3. The air accelerator and air cooler apparatus in internal combustion engines according to claim 1, wherein the number of holes, the wall thickness of the apparatus, the diameter width of the apparatus and the hole angles can vary according to the vehicle.

4. The air accelerator and air cooler apparatus in internal combustion engines according to claim 1, wherein the diameter of the holes drilled between 30 and 45 degrees on the conical structure surface is minimum 3 mm and maximum 25 mm.

5. The air accelerator and air cooler apparatus in internal combustion engines according to claim 1, wherein the initial narrow part of the conical structure has the diameters of the hole from 15 to 80 mm.

6. The air accelerator and air cooler apparatus in internal combustion engines according to claim 1, wherein the diameter of the wide side of the conical structure is minimum 40 mm and maximum 250 mm.

7. The accelerator and air cooler apparatus in internal combustion engines according to claim 1, being used
in the air intake pipe before the part called the throttle valve or
in the turbo engine inlet with the air filter or
inside the exhaust line before the exhaust silencer or
in the liquid cooling return line before the radiator inlet or
before the heat exchanger in vehicles with hydraulic components.
